(19) United States
(12) Patent Application Publication
(10) Pub. No.: US 2021/0023963 A1
(43) Pub. Date: Jan. 28, 2021

(54) CHARGING MANAGEMENT SYSTEM

(71) Applicant: TOYOTA JIDOSHA KABUSHIKI KAISHA, Toyota-shi (JP)

(72) Inventors: Ikuo OHTA, Toyota-shi (JP); Hideshi MIZUTANI, Toyota-shi (JP); Atsushi SAJIKI, Okazaki-shi (JP); Takao INATA, Setagaya-ku (JP); Yohei TANIGAWA, Toyota-shi (JP); Atsushi NAKAJIMA, Kariya-city. (JP); Atsuo KOMATSUBARA, Nagakute-shi (JP)

(21) Appl. No.: 16/932,955

(22) Filed: Jul. 20, 2020

(30) Foreign Application Priority Data
Jul. 26, 2019 (JP) 2019-137820

(51) Int. Cl. B60L 58/22; H02J 7/00

(52) U.S. Cl. CPC B60L 58/22; H02J 7/005; H02J 7/0014

(57) ABSTRACT

A charging management system according to the present disclosure is a system for charging a plurality of batteries that are respectively mounted on a plurality of electric automobiles connected to a charging facility, the charging management system including: a collection unit configured to collect charging characteristics of the plurality of batteries; and a determination unit configured to determine a distribution of an amount of charging power to be supplied to the plurality of batteries from the charging facility based on the charging characteristics collected by the collection unit. The determination unit determines to supply the batteries having the same charging characteristics as each other with the same amount of charging power as each other, and determines to supply the batteries having charging characteristics different from each other with amounts of charging power different from each other.

### CROSS REFERENCE TO RELATED APPLICATIONS

This application is based upon and claims the benefit of priority from Japanese patent application No. 2019-137820, filed on Jul. 26, 2019, the disclosure of which is incorporated herein in its entirety by reference.

### BACKGROUND

The present disclosure relates to a charging management system.

In recent years, in parking lots in airports etc., attempts have been made to provide services for vehicles parked in such parking lots. For example, Japanese Unexamined Patent Application Publication No. 2007-006574 discloses a technique for receiving power supplied from a fuel cell automobile parked in a parking lot and supplying hydrogen as fuel to the fuel cell automobile.

### SUMMARY

The number of parking lots in which a charging facility is installed and electric automobiles parked in the parking lot can be charged from the charging facility has been increasing recently.

However, batteries of electric automobiles may have charging characteristics different from each other in accordance with the type of the battery.

Consequently, when a plurality of electric automobiles are connected to the charging facility, charging cannot be optimally performed if the types of batteries among the plurality of electric automobiles are different.

The present disclosure has been made in view of the above circumstances and an object thereof is to provide a charging management system that can optimally perform charging even when a plurality of electric automobiles including batteries of types different from each other are connected to a charging facility.

A first exemplary aspect is a charging management system for charging a plurality of batteries that are respectively mounted on a plurality of electric automobiles connected to a charging facility, the charging management system including:

a collection unit configured to collect charging characteristics of the plurality of batteries; and

a determination unit configured to determine a distribution of an amount of charging power to be supplied to the plurality of batteries from the charging facility based on the charging characteristics collected by the collection unit, in which

the determination unit determines to supply the batteries having charging characteristics the same as each other with an amount of charging power the same as each other, and determines to supply the batteries having charging characteristics different from each other with amounts of charging power different from each other.

According to the present disclosure, it is possible to provide a charging management system that can optimally perform charging even when a plurality of electric automobiles including batteries of types different from each other are connected to a charging facility.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram for explaining a premise configuration of a charging management system according to an embodiment;

FIG. 2 is a block diagram showing a configuration example of the charging management system according to the embodiment;

FIG. 3 is a flowchart showing a flow of processing performed by the charging management system according to the embodiment;

FIG. 4 is a diagram showing an example of a charging-power distribution determined by a determination unit of the charging management system according to the embodiment;

FIG. 5 is a diagram showing an example of a charging-power distribution determined by the determination unit of the charging management system according to the embodiment; and

FIG. 6 is a diagram showing an example of a charging-power distribution determined by the determination unit of the charging management system according to the embodiment.

### DESCRIPTION OF EMBODIMENTS

Hereinafter, although the present disclosure will be described with reference to an embodiment of the present disclosure, the present disclosure according to claims is not limited to the following embodiment. Moreover, all the components described in the following embodiment are not necessarily essential as means for solving problems. For the clarification of the description, the following description and drawings are omitted or simplified as appropriate. Throughout the following drawings, the same components are denoted by the same reference signs and repeated descriptions will be omitted as appropriate.

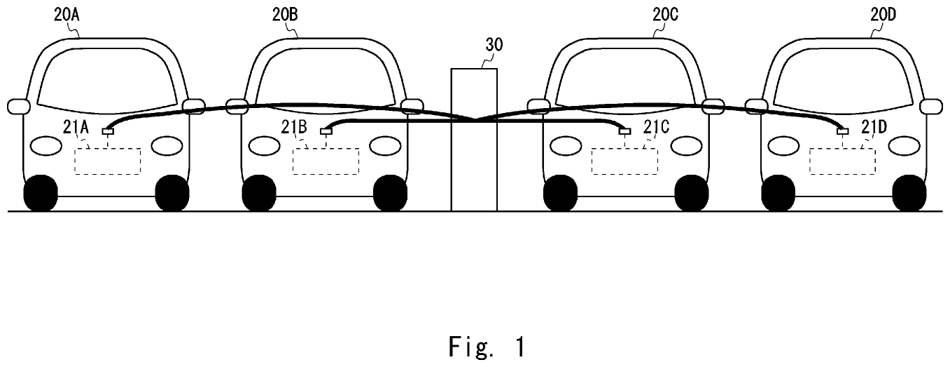

First, a premise configuration as a premise of a charging management system 1 according to this embodiment is described with reference to FIG. 1.

As shown in FIG. 1, in a parking lot in an airport, a charging facility 30 capable of charging batteries 21A to 21D (hereinafter referred to as batteries 21 when it is not necessary to specify the batteries 21A to 21D) respectively mounted on a plurality of electric automobiles 20A to 20D (hereinafter referred to as electric automobiles 20 when it is not necessary to specify the electric automobiles 20A to 20D) is installed. Note that although FIG. 1 shows an example in which the charging facility 30 charges the four batteries 21, the number of batteries 21 charged by the charging facility 30 is not limited to four and may be any number as long as it is a plural number.

The charging management system 1 according to this embodiment is a system for determining a distribution (charging-power distribution) of the amount of charging power to be supplied from the charging facility 30 to a plurality of batteries 21 under the above-described premise configuration.

Note that the electric automobile 20 may be any vehicle including the battery 21 mounted thereon. For example, the electric automobile 20 may be an electric vehicle (EV), a plug-in hybrid vehicle (PHV), a plug-in fuel cell vehicle (plug-in FCV), or the like.

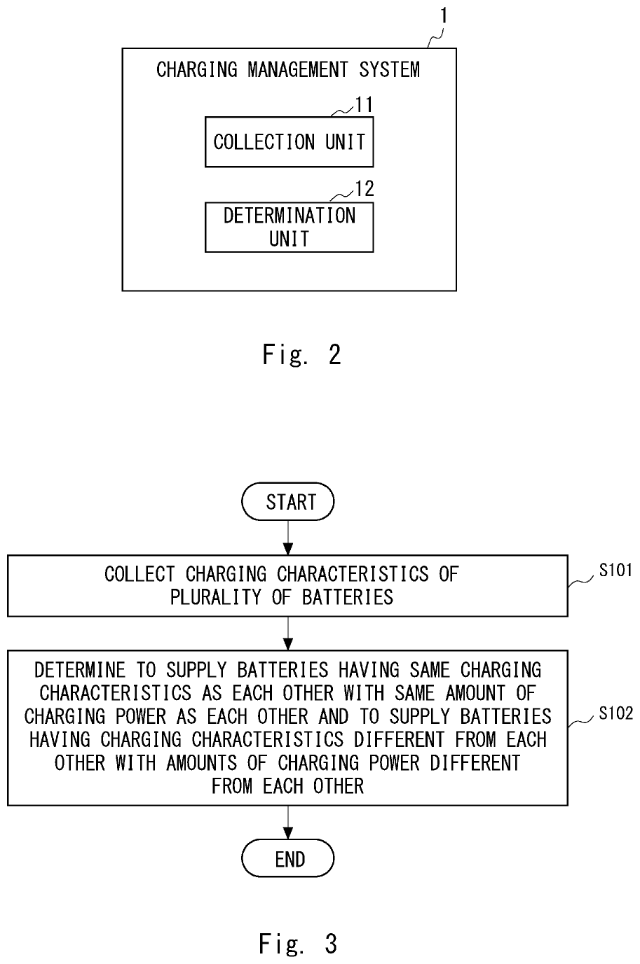

Next, a configuration example of the charging management system 1 according to this embodiment is described with reference to FIG. 2.

As shown in FIG. 2, the charging management system 1 according to this embodiment includes a collection unit 11 and a determination unit 12.

The collection unit 11 collects charging characteristics of the plurality of batteries 21 that are respectively mounted on the plurality of electric automobiles 20 connected to the charging facility 30. The charging characteristic is, for example, a maximum amount of charging power, which is the maximum amount of charging power that can be received by the battery 21.

For example, the collection unit 11 may collect a charging characteristic of the battery 21 by installing an input device in a parking space in which the charging facility 30 is installed and having a driver of the electric automobile 20 manually input the charging characteristic of the battery 21. Alternatively, the collection unit 11 may retain a correspondence table associating a type of the electric automobile 20 with a charging characteristic of the battery 21, have a driver of the electric automobile 20 manually input the vehicle type of the electric automobile 20, and then convert the vehicle type of the electric automobile 20 into the charging characteristic of the battery 21 using the correspondence table. Alternatively, by installing a photographing apparatus in the parking space in which the charging facility 30 is installed and recognizing the image of the electric automobile 20 taken by the photographing apparatus, the collection unit 11 may collect a type of the electric automobile 20, and convert the type of the electric automobile 20 into the charging characteristic of the battery 21 using the correspondence table as described above.

The determination unit 12 determines a distribution (charging-power distribution) of the amount of charging power to be supplied from the charging facility 30 to the plurality of batteries 21 based on the charging characteristics of the plurality of batteries 21 collected by the collection unit 11. More specifically, the determination unit 12 determines to supply the batteries 21 having the same charging characteristics as each other with the same amount of charging power as each other. Further, the determination unit 12 determines to supply the batteries 21 having charging characteristics different from each other with amounts of charging power different from each other.

As described above, the charging characteristic is, for example, the maximum amount of charging power. When the charging characteristic is the maximum amount of charging power, the determination unit 12 may determine an amount of charging power to be supplied to each of the plurality of batteries 21 so that the amount of charging power does not exceed the maximum amount of charging power of each of the plurality of batteries 21. Alternatively, the determination unit 12 may determine an amount of charging power to be supplied to each of the plurality of batteries 21 so that the amount of charging power does not exceed the maximum amount of charging power of each of the plurality of batteries 21 and so that the larger the maximum amount of charging power of the battery 21 is, the larger the amount of charging power that is supplied. Note that a specific method for determining the amount of charging power to be supplied to each of the plurality of batteries 21 by the determination unit 12 will be described later.

This embodiment is directed to the electric automobile 20 including the battery 21 mounted thereon, and in order to charge the battery 21 in the parking lot, it is necessary to guide the electric automobile 20 to the parking space in which the charging facility 30 is installed.

Therefore, for example, in a parking lot in an airport, an entrance gate dedicated to the electric automobile 20 may be installed, and a parking space dedicated to the electric automobile 20 which can be reached only from the dedicated entrance gate and in which the charging facility 30 is installed may be installed. By doing so, the electric automobile 20 can be guided to the parking space in which the charging facility 30 is installed.

Alternatively, in the parking lot in the airport, the electric automobile 20 may be guided by installing a common entrance gate for the electric automobile 20 and vehicles other than the electric automobile 20 (i.e., vehicles including no battery 21 mounted thereon), identifying the vehicle at the entrance gate whether or not it is the electric automobile 20, and outputting a voice message or a display message to the identified electric automobile 20 instructing a driver to go to the parking space in which the charging facility 30 is installed. At this time, for example, the type of the vehicle may be determined by installing a photographing apparatus at the common entrance gate and recognizing the image of the vehicle taken by the photographing apparatus, and it may be identified whether the vehicle is the electric automobile 20 from the determined type of the vehicle.

Further, regarding the electric automobile 20, it is necessary to not only guide it so that it parks in the parking space in which the charging facility 30 is installed, but also to cause the battery 21 to be connected to the charging facility 30. Therefore, for example, the charging facility 30 may prompt the electric automobile 20 parked in the parking space in which the charging facility 30 is installed to connect the battery 21 to the charging facility 30 by outputting, to the electric automobile 20, a voice message or a display message instructing that the battery 21 be connected to the charging facility 30.

Next, a flow of processing performed by the charging management system 1 according to this embodiment is described with reference to FIG. 3.

As shown in FIG. 3, first, the collection unit 11 collects charging characteristics of the plurality of batteries 21 that are respectively mounted on the plurality of electric automobiles 20 connected to the charging facility 30 (Step S101).

Next, the determination unit 12 determines a distribution (charging-power distribution) of the amount of charging power supplied from the charging facility 30 to the plurality of batteries 21 based on the charging characteristics of the plurality of batteries 21 collected by the collection unit 11. More specifically, the determination unit 12 determines to supply the batteries 21 having the same charging characteristics as each other with the same amount of charging power as each other. Further, the determination unit 12 determines to supply the batteries 21 having charging characteristics different from each other with amounts of charging power different from each other (Step S102).

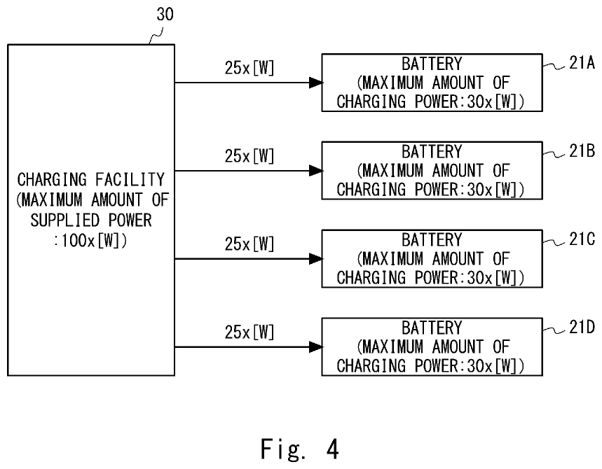

Next, a specific method for determining the amount of charging power to be supplied to each of the plurality of batteries 21 by the determination unit 12 is described below with reference to FIGS. 4 to 6.

In this example, it is assumed that the collection unit 11 collects the maximum amount of charging power as a charging characteristic. Further, it is assumed that the maximum amount of supplied power, which is the maximum amount of power that can be supplied from the charging facility 30, is 100×[W]. Further, it is assumed that the four electric automobiles 20A to 20D are connected to the charging facility 30, and the four electric automobiles 20A to 20D, respectively, include the batteries 21A to 21D mounted thereon. Further, it is assumed that the determination unit 12 determines the amount of charging power to be supplied to each of the four batteries 21A to 21D so that the amount of charging power does not exceed the maximum amount of charging power of each of the four batteries 21A to 21D and so that the larger the maximum amount of charging power of the battery 21 becomes, the larger the amount of charging power that is supplied.

First, the example shown in FIG. 4 is described. FIG. 4 is an example in which the maximum amounts of charging power of the four batteries 21A to 21D are the same. Specifically, the maximum amounts of charging power of the four batteries 21A to 21D are all 30×[W].

In the example of FIG. 4, the determination unit 12 determines to supply the same amount of charging power to the four batteries 21A to 21D. Further, the determination unit 12 does not allow the amount of charging power supplied to each of the four batteries 21A to 21D to exceed the maximum amount of charging power.

On the basis of the above, the determination unit 12 determines the amount of charging power to be supplied to each of the four batteries 21A to 21D to be 25×[W].

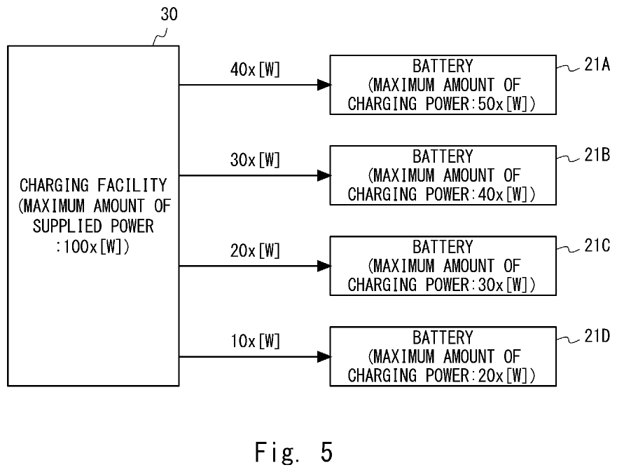

Next, the example shown in FIG. 5 is described. FIG. 5 is an example in which the maximum amounts of charging power of the four batteries 21A to 21D are different. Specifically, the maximum amounts of charging power of the batteries 21A to 21D are 50×[W], 40×[W], 30×[W], and 20×[W], respectively.

In the example of FIG. 5, the determination unit 12 determines to supply different amounts of charging power to the four batteries 21A to 21D. Further, the determination unit 12 does not allow the amount of charging power supplied to each of the four batteries 21A to 21D to exceed the maximum amount of charging power. Further, the determination unit 12 determines to supply an amount of charging power that becomes larger as the maximum amount of charging power of the battery 21 becomes larger.

On the basis of the above, the determination unit 12 determines the amount of charging power to be supplied to the four batteries 21A to 21D to be 40×[W], 30×[W], 20×[W], and 10×[W], respectively.

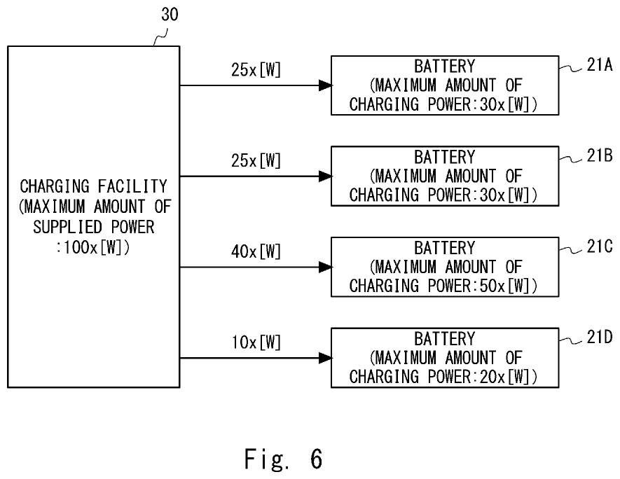

Next, the example shown in FIG. 6 is described. FIG. 6 shows an example in which the maximum amounts of charging power of only some of the four batteries 21A to 21D are the same. Specifically, the maximum amounts of charging power of the two batteries 21A and 21B are the same. Further, the maximum amounts of charging power of the four batteries 21A to 21D are 30×[W], 30×[W], 50×[W], and 20×[W], respectively.

In the example of FIG. 6, the determination unit 12 determines to supply the same amount of charging power to the two batteries 21A and 21B. Further, the determination unit 12 determines to supply different amounts of charging power to the batteries 21A and 21B, the battery 21C, and the battery 21D. Further, the determination unit 12 does not allow the amount of charging power supplied to each of the four batteries 21A to 21D to exceed the maximum amount of charging power. Further, the determination unit 12 determines to supply an amount of charging power that becomes larger as the maximum amount of charging power of the battery 21 becomes larger.

On the basis of the above, the determination unit 12 determines the amount of charging power to be supplied to the four batteries 21A to 21D to be 25×[W], 25×[W], 40×[W], and 10×[W], respectively.

Note that in the examples of FIGS. 4 to 6, although the determination unit 12 distributes charging power of 100×[W] corresponding to the maximum amount of power supplied from the charging facility 30, the amount of charging power to be distributed is not limited to this. The determination unit 12 may distribute charging power less than the maximum amount of power supplied from the charging facility 30.

Next, an effect of the charging management system 1 according to this embodiment is described.

In the charging management system 1 according to this embodiment, charging characteristics of the plurality of batteries 21 that are respectively mounted on the plurality of electric automobiles 20 connected to the charging facility 30 are collected, the batteries 21 having the same charging characteristics as each other are determined to be supplied with the same amount of charging power as each other, and the batteries 21 having charging characteristics different from each other are determined to be supplied with amounts of charging power different from each other.

By this configuration, the plurality of batteries 21 can be charged with the optimal distribution of the amount of power in accordance with the charging characteristics of the plurality of batteries 21. Thus, it is possible to optimally perform charging even when the plurality of electric automobiles 20 including batteries 21 of types different from each other are connected to the charging facility.

Note that the present disclosure is not limited to the above-described embodiment and can be modified as appropriate without departing from the spirit of the present disclosure.

For example, while the example in which the charging facility is installed in a parking lot in an airport has been described in the above embodiment, the present disclosure is not limited to this example. The present disclosure can be applied also to a case in which the charging facility is not installed in an airport and a case in which the charging facility is not installed in a parking lot.

Further, in the above-described embodiments, the charging management system according to the present disclosure has been described as a hardware configuration, but the present disclose is not limited thereto. In the present disclosure, any processing of the charging management system can be achieved by a processor, such as a CPU (Central Processing Unit), loading and executing a computer program stored in a memory.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A charging management system for charging a plurality of batteries that are respectively mounted on a plurality of electric automobiles connected to a charging facility, the charging management system comprising:
a collection unit configured to collect charging characteristics of the plurality of batteries; and
a determination unit configured to determine a distribution of an amount of charging power to be supplied to the plurality of batteries from the charging facility based on the charging characteristics collected by the collection unit, wherein
the determination unit determines to supply the batteries having charging characteristics the same as each other with an amount of charging power the same as each other, and determines to supply the batteries having charging characteristics different from each other with amounts of charging power different from each other.

2. The charging management system according to claim 1, wherein the charging characteristic is a maximum amount of charging power, which is the maximum amount of charging power that can be received by the battery.

3. The charging management system according to claim 2, wherein the determination unit determines an amount of charging power to be supplied to each of the plurality of batteries so that the amount of charging power does not exceed the maximum amount of charging power of each of the plurality of batteries.

4. The charging management system according to claim 2, wherein the determination unit determines an amount of charging power to be supplied to each of the plurality of batteries so that the amount of charging power does not exceed the maximum amount of charging power of each of the plurality of batteries and so that the larger the maximum amount of charging power of the battery becomes, the larger the amount of charging power that is supplied.

5. The charging management system according to claim 1, wherein the charging facility is installed in a parking lot in an airport.
